(19) United States
(12) Patent Application Publication
(10) Pub. No.: US 2026/0249272 A1
(43) Pub. Date: Aug. 27, 2026

(54) CATALYST FOR DECOMPOSING PERFLUOROCOMPOUNDS

(71) Applicant: ECOPROHN CO., LTD., Chungcheongbuk-do (KR)

(72) Inventors: JIN HONG KIM, Seoul (KR); MIN JI KIM, Chungcheongbuk-do (KR); SEUNG HWAN JI, Chungcheongnam-do (KR); HYE IN LEE, Chungcheongbuk-do (KR); HYE JIN AN, Chungcheongbuk-do (KR)

(21) Appl. No.: 18/992,347

(22) PCT Filed: Jul. 14, 2023
(86) PCT No.: PCT/KR2023/010065

§ 371 Date: Jan. 8, 2025

(30) Foreign Application Priority Data
Aug. 4, 2022 (KR) 10-2022-0097382

(51) Int. Cl. B01J 21/04; B01D 53/86; B01J 21/06; B01J 23/06; B01J 23/08; B01J 23/10; B01J 27/16; B01J 27/25; B01J 35/57; B01J 35/70; B01J 37/00; B01J 37/04

(52) U.S. Cl. CPC B01J 21/04; B01D 53/8662; B01J 21/066; B01J 23/06; B01J 23/08; B01J 23/10; B01J 27/16; B01J 27/25; B01J 35/57; B01J 35/70; B01J 37/0009; B01J 37/04; B01D 2255/2065; B01D 2255/20715; B01D 2255/20792; B01D 2255/209; B01D 2255/70; B01D 2257/2066

(57) ABSTRACT

A catalyst for perfluorinated compound decomposition includes a first catalyst which includes an aluminum oxide, and a second catalyst which includes at least one oxide selected from the group consisting of Zr, Ce and Ga, wherein a ratio of a weight of the second catalyst to a total weight of the first catalyst is 0.02 to 0.3. The lifespan characteristics and initial activity of the catalyst for perfluorinated compound decomposition may be improved.

### BACKGROUND

### Field of the Invention

The present invention relates to a catalyst for perfluorinated compound decomposition.

### Description of the Related Art

Perflurocompounds (PFCs) (hereinafter, perfluorinated compounds) are compounds in which a large amount of fluorine (F) is substituted in aliphatic hydrocarbons, and regulations on them have been strengthened in recent years. The perfluorinated compounds have a global warming potential which is thousands to tens of thousands of times greater than that of carbon dioxide, and are pointed out as a main cause of global warming. In addition, some of these perfluorinated compounds are used as a coating agent for a cooking utensil or paper cup, or as a refrigerant, but are believed to cause brain, nerve and/or liver toxicity, and disrupt hormones.

A main generation source of the perfluorinated compounds is a production process of semiconductor devices such as a memory or LCD. For example, the perfluorinated compounds (e.g., CF₄) are emitted in large quantities after they are widely used as an etching reagent in an etching process and as a reactor cleaner in a chemical vapor deposition process during the semiconductor production process.

As a method of removing the perfluorinated compound, a catalytic decomposition method capable of decomposition at low temperature may be used. The catalytic decomposition method may include, for example, a process of passing the perfluorinated compound through a harmful gas decomposition apparatus including a catalyst layer. During the passage process, a pressure loss occurs, and if the pressure loss of the entire facility is increased, it may be difficult to operate the facility for a long period of time.

In addition, as a main material of the catalyst for decomposition of perfluorinated compounds, alumina (Al₂O₃) may be used. However, the alumina catalyst undergoes a phase change when exposed to perfluorinated compounds for a long period of time, which may reduce the efficiency of the catalyst.

Accordingly, a catalyst for perfluorinated compound decomposition with improved lifespan characteristics and structural stability is required. For example, Korean Patent Registration No. 10-2476223 discloses an apparatus for removing a perfluorinated compound, but there is a limitation in securing sufficient lifespan characteristics and stability.

### SUMMARY

An object of the present invention is to provide a catalyst for perfluorinated compound decomposition with improved lifespan characteristics and stability.

1. A catalyst for perfluorinated compound decomposition including: a first catalyst which includes an aluminum oxide; and a second catalyst which includes at least one oxide selected from the group consisting of Zr, Ce and Ga, wherein a ratio of a weight of the second catalyst to a total weight of the first catalyst is 0.02 to 0.3.

2. The catalyst for perfluorinated compound decomposition according to the above 1, wherein the aluminum oxide includes at least one form selected from the group consisting of boehmite (hydrated alumina), alpha alumina (α-alumina), gamma alumina (γ-alumina), delta alumina (δ-alumina) and theta alumina (θ-alumina).

3. The catalyst for perfluorinated compound decomposition according to the above 1, wherein the second catalyst includes at least one selected from the group consisting of zirconium oxide (ZrO₂), cerium oxide (CeO₂) and gallium oxide (Ga₂O₃).

4. The catalyst for perfluorinated compound decomposition according to the above 1, wherein the second catalyst includes at least one selected from the group consisting of zirconium oxide, cerium oxide and gallium oxide, and a mixed phase of alumina and phosphorus.

5. The catalyst for perfluorinated compound decomposition according to the above 1, further including a third catalyst which includes a phosphorus-containing compound.

6. The catalyst for perfluorinated compound decomposition according to the above 5, wherein a ratio of a converted weight of phosphorus included in the third catalyst to a total weight of the first catalyst is 0.01 to 0.1, and the converted weight of phosphorus is a weight obtained by converting the content of phosphorus included in the third catalyst to a content of P₂O₅.

7. The catalyst for perfluorinated compound decomposition according to the above 5, wherein the third catalyst further includes a compound containing at least one selected from the group consisting of B, S, P, Cs, Ca and K.

8. The catalyst for perfluorinated compound decomposition according to the above 5, further including a fourth catalyst which includes at least one oxide selected from the group consisting of Zn, Ni, W, Co, Ni, Cr and Mo.

9. The catalyst for perfluorinated compound decomposition according to the above 1, wherein a ratio of a crystal structure of the second catalyst, which is measured through X-ray diffraction (XRD) analysis and defined by Equation 1 below, is 0.2 to 0.9:

$$Ratio of crystal structures = A / B \qquad [ Equation 1 ]$$

(in Equation 1, A is an XRD peak area corresponding to a monoclinic crystal structure of the second catalyst, and B is an XRD peak area corresponding to a tetragonal crystal structure of the second catalyst).

10. The catalyst for perfluorinated compound decomposition according to the above 9, wherein a ratio of the weight of the fourth catalyst to the total weight of the first catalyst is 0.01 to 0.2.

11. The catalyst for perfluorinated compound decomposition according to the above 1, wherein a ratio of the weight of the first catalyst to a total weight of the catalyst for perfluorinated compound decomposition is 0.67 to 0.96.

12. The catalyst for perfluorinated compound decomposition according to the above 1, wherein the catalyst has a honeycomb structure shape which includes a plurality of through channels formed therein.

13. The catalyst for perfluorinated compound decomposition according to the above 12, wherein the number of through channels per square inch (CPSI) in a planar direction perpendicular to an extension direction of the plurality of through channels is 50 to 150.

14. The catalyst for perfluorinated compound decomposition according to the above 12, wherein a channel length ratio defined by Equation 2 below is 1 to 5:

$$Channel length ratio = L / T \qquad [ Equation 2 ]$$

(in Equation 2, L is a length of a major axis of each of the plurality of through channels in the planar direction, and T is the shortest distance between a through channel adjacent to one side of the catalyst for perfluorinated compound decomposition and the one side).

15. An apparatus for perfluorinated compound decomposition including: a catalyst layer which includes the catalyst for perfluorinated compound decomposition of the above 12; and a heat storage body disposed on a lower portion of the catalyst layer.

In exemplary embodiments, the catalyst for perfluorinated compound decomposition includes a first catalyst including an aluminum oxide and a second catalyst including at least one oxide selected from the group consisting of Zr, Ce and Ga. The ratio of the weight of the first catalyst and the second catalyst may be adjusted to a predetermined range, thereby improving the decomposition performance and initial efficiency of the catalyst.

In some embodiments, the catalyst for perfluorinated compound decomposition may further include a third catalyst including a phosphorus-containing compound. Accordingly, the durability and stability of the catalyst for perfluorinated compound decomposition may be improved.

In some embodiments, the catalyst for perfluorinated compound decomposition may further include a fourth catalyst including at least one oxide selected from the group consisting of Zn, Ni, W, Co, Ni, Cr and Mo. Accordingly, performances of the first catalyst and the second catalyst may be improved.

In some embodiments, the catalyst for perfluorinated compound decomposition may have a honeycomb structure shape including a plurality of through channels. Accordingly, a specific surface area that can react with a gas to be treated may be increased, thereby improving an efficiency of removing harmful gases.

In some embodiments, a ratio between the length of the through channel in a planar direction and the wall thickness of the catalyst for perfluorinated compound decomposition may be adjusted to a predetermined range. Accordingly, the specific surface area of the catalyst for perfluorinated compound decomposition may be increased while suppressing the pressure loss of a gas to be treated.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a catalyst for perfluorinated compound decomposition according to exemplary embodiments;

FIG. 2 is a schematic plan view illustrating the catalyst for perfluorinated compound decomposition according to exemplary embodiments;

FIG. 3 is a schematic cross-sectional view illustrating a reactor including the catalyst for perfluorinated compound decomposition according to exemplary embodiments;

FIGS. 4 and 5 are graphs illustrating XRD analysis results of Examples 6, 11 and 12; and

FIGS. 6 and 7 are graphs illustrating XRD analysis results of Examples 15 and 19.

### DETAILED DESCRIPTION OF THE INVENTION

The embodiments of the present invention provide a catalyst for perfluorinated compound decomposition including two or more different catalysts.

Hereinafter, embodiments of the present invention will be described in detail. However, these are merely exemplary and the present invention is not limited to the specific embodiments described by way of example.

For example, the perfluorinated compounds (PFCs) may include CF₄, CHF₃, C₃F₆, CH₂F₂, C₃F₄, C₂F₆, C₃F₈, C₄F₁₀, C₅F₈, SF₆, NF₃, etc.

In exemplary embodiments, the catalyst for perfluorinated compound decomposition may include a first catalyst and a second catalyst which include different compounds from each other.

In exemplary embodiments, the first catalyst may include an aluminum oxide. Accordingly, the chemical resistance of the catalyst for perfluorinated compound decomposition to hydrofluoric acid derived from a gas to be reacted and acidic substances introduced from a semiconductor process may be improved. Accordingly, the performance and durability of the catalyst for perfluorinated compound decomposition may be improved.

For example, the first catalyst may be provided as a cater.

For example, the aluminum oxide may include at least one form selected from the group consisting of boehmite (hydrated alumina), alpha alumina (α-alumina), gamma alumina (γ-alumina), delta alumina (δ-alumina) and theta alumina (θ-alumina).

In exemplary embodiments, the second catalyst may include at least one oxide selected from the group consisting of zirconium (Zr), cerium (Ce) and gallium (Ga).

For example, the second catalyst may be provided as a main catalyst, whereby direct decomposition, hydrolysis and/or oxidative decomposition reactions of the perfluorinated compounds may be performed.

For example, the second catalyst may include at least one selected from the group consisting of zirconium oxide (ZrO₂), cerium oxide (CeO₂) and gallium oxide (Ga₂O₃).

For example, the second catalyst may be present in a mixed phase of at least one selected from the group consisting of zirconium oxide, cerium oxide and gallium oxide, and alumina and phosphorus.

In exemplary embodiments, a ratio of the weight of the second catalyst to a total weight of the first catalyst may be 0.02 to 0.3.

If the ratio of the weight of the second catalyst to the total weight of the first catalyst is less than 0.02, a metal oxide of the second catalyst may be introduced too little, thereby causing a decrease in the decomposition performance of the perfluorinated compounds.

If the ratio of the weight of the second catalyst to the total weight of the first catalyst exceeds 0.3, an effect of decomposing the perfluorinated compound relative to the weight of the introduced second catalyst may be reduced.

For example, the above-described first catalyst and the second catalyst may each be present in the catalyst for perfluorinated compound decomposition, and may interact with other components to form a composite metal oxide.

In some embodiments, the catalyst for perfluorinated compound decomposition may further include a third catalyst including a phosphorus (P)-containing compound.

The phosphorus-containing compound may transform crystal structure(s) of the first catalyst and/or the second catalyst. For example, phosphorus contained in the phosphorus-containing compound may stabilize the crystal structure of the aluminum oxide included in the first catalyst. For example, the phase transition of the aluminum oxide having a gamma-alumina (γ-alumina) crystal structure into an alpha-alumina (α-alumina) crystal structure may be inhibited by the phosphorus-containing compound, thereby enhancing the stability of the catalyst structure. Accordingly, the durability and stability of the catalyst for perfluorinated compound decomposition may be improved.

For example, the phosphorus-containing compound may include at least one selected from the group consisting of P₂O₅, AlPO₄, and materials formed in a mixed phase of alumina and phosphoric acid.

In some embodiments, a ratio of the converted weight of phosphorus included in the third catalyst to the total weight of the first catalyst may be 0.01 to 0.1. The converted weight of phosphorus is a weight obtained by converting the phosphorus content included in the third catalyst into a content of P₂O₅.

Within the above range, the lifespan characteristics of the catalyst for perfluorinated compound decomposition may be improved while the transformation of aluminum oxide into aluminum phosphate (AlPO₄) may be suppressed. Accordingly, a decrease in the initial activity may be prevented while improving the lifespan characteristics of the catalyst for perfluorinated compound decomposition.

In some embodiments, the third catalyst may further include a compound containing at least one selected from the group consisting of B, S, P, Cs, Ca and K. Accordingly, the lifespan characteristics and initial activity of the catalyst for perfluorinated compound decomposition may be adjusted such that a catalyst having desired properties may be prepared.

According to some embodiments, the phosphorus-containing compound of the third catalyst may transform the crystal structure of the metal oxide included in the second catalyst.

For example, a ratio of a crystal structure of the second catalyst, which is measured through X-ray diffraction (XRD) analysis and defined by Equation 1 below, may be 0.2 to 0.9.

$$Ratio of crystal structures = A / B \qquad [ Equation 1 ]$$

In Equation 1, A is an XRD peak area corresponding to a monoclinic crystal structure of the second catalyst, and B is an XRD peak area corresponding to a tetragonal crystal structure of the second catalyst.

According to some embodiments, the catalyst for perfluorinated compound decomposition may further include a fourth catalyst including a different material from the first catalyst, the second catalyst and the third catalyst. For example, the fourth catalyst may be provided as a cocatalyst to complement the function of the main catalyst (e.g., the second catalyst) or have a catalytic function by itself.

For example, the fourth catalyst may include at least one oxide selected from the group consisting of Zn, Ni, W, Co, Cr and Mo.

For example, the fourth catalyst may include at least one selected from the group consisting of ZnO, NiO, WO₃, CoO, Cr₂O₃ and MoO₂.

In some embodiments, a ratio of the weight of the fourth catalyst to the total weight of the first catalyst may be 0.01 to 0.2. Within the above range, the removal performance of the perfluorinated compounds may be improved while stably maintaining the crystal structures of the first catalyst and the second catalyst.

According to one embodiment, a ratio of the weight of the first catalyst to a total weight of the catalyst for perfluorinated compound decomposition may be 0.67 to 0.96. Within the above range, the durability and initial activity of the catalyst for perfluorinated compound decomposition may be improved by adjusting the contents of the second catalyst, the third catalyst and the fourth catalyst to the above-described range.

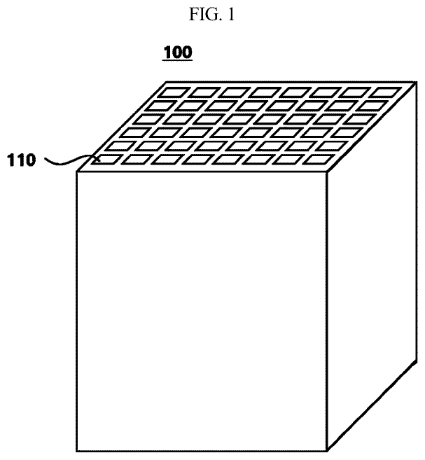

FIG. 1 is a schematic view illustrating a catalyst for perfluorinated compound decomposition according to exemplary embodiments.

Hereinafter, the structure of the catalyst for perfluorinated compound decomposition according to exemplary embodiments will be described with reference to the drawings. However, the drawings are intended to describe exemplary embodiments, and the shape of the present invention is not limited to the shape shown in the drawings.

Referring to FIG. 1, a catalyst 100 for perfluorinated compound decomposition described above may have a honeycomb structure shape.

The honeycomb structure shape may have, for example, a plurality of through channels 110 through which a gas to be treated (for example, a perfluorinated compound gas) may pass therethrough. Accordingly, the catalyst having the honeycomb structure shape has a large specific surface area that can react with the gas to be treated, such that the efficiency of removing harmful gases may be improved.

For example, the honeycomb structure shape may have a monolithic shape. Accordingly, when the gas to be treated passes through the catalyst 100 for perfluorinated compound decomposition, a pressure loss may be reduced.

For example, the honeycomb structure may have a shape such as a hexahedron, a triangular prism, a pentagonal prism, a hexagonal prism, etc., and preferably has a hexahedron or an equilateral triangular prism shape. In this case, a space efficiency of the reactor, in which the catalyst 100 for perfluorinated compound decomposition having the honeycomb structure shape is installed, may be improved.

For example, the catalyst 100 for perfluorinated compound decomposition having the honeycomb structure shape may have a length of 50 to 150 mm, and a height of 50 to 150 mm of each side of a base side.

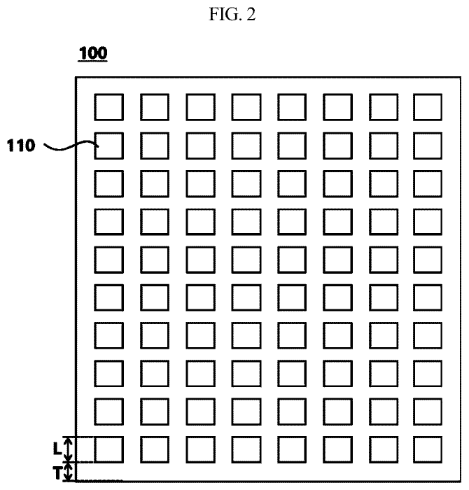

FIG. 2 is a schematic plan view illustrating the catalyst for perfluorinated compound decomposition according to exemplary embodiments.

For example, the more the number of through channels 110 per unit area, the more the specific surface area is increased, thereby improving the decomposition performance of the catalyst, but the pressure loss may be increased when the gas to be treated passes through.

Referring to FIG. 2, the number of through channels 110 per square inch (channels per square inch, CPSI) in a planar direction perpendicular to an extension direction of the plurality of through channels 110 may be 50 to 150.

The term “planar direction” as used herein may mean a direction looking at a cross-section of the catalyst 100 for perfluorinated compound decomposition perpendicular to a thickness direction of the catalyst 100 for perfluorinated compound decomposition (e.g., the extension direction of the plurality of through channels 110).

Within the above CPSI range, as the specific surface area of the catalyst 100 for perfluorinated compound decomposition is increased, excessive pressure loss may be prevented while improving the performance.

According to some embodiments, a channel length ratio defined by Equation 2 below may be 1 to 5.

$$Channel length ratio = L / T \qquad [ Equation 2 ]$$

In Equation 2, L is a length of a major axis of each of the plurality of through channels 110 in the planar direction, and T is the shortest distance between a through channel 110 adjacent to one side of the catalyst 100 for perfluorinated compound decomposition and the one side.

The channel length ratio may mean, for example, a ratio between a length L of one side of the through channel 110 in the planar direction and a wall thickness T of the catalyst 100 for perfluorinated compound decomposition.

Within the above range of the channel length ratio, an effect of improving the specific surface area may be sufficiently implemented while suppressing the pressure loss.

According to one embodiment, the shape and size of each of the plurality of through channels 110 in the planar direction may be substantially the same.

Hereinafter, a reactor including the above-described catalyst for perfluorinated compound decomposition will be described. However, the reactor is only an example of using the catalyst for perfluorinated compound decomposition, and the use of the catalyst for perfluorinated compound decomposition is not limited to the reactor.

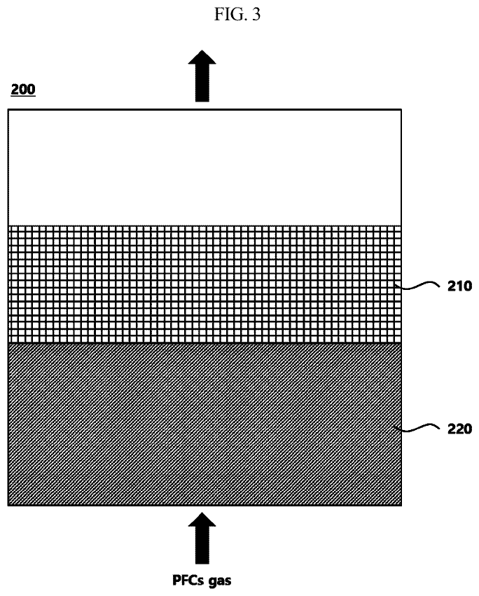

FIG. 3 is a schematic cross-sectional view illustrating the reactor including the catalyst for perfluorinated compound decomposition according to exemplary embodiments.

Referring to FIG. 3, a reactor 200 including the catalyst 100 for perfluorinated compound decomposition may be formed.

According to some embodiments, a plurality of catalysts 100 for perfluorinated compound decomposition having a honeycomb structure shape may be bonded or adhered in the planar direction or a vertical direction to form a catalyst layer 210.

The reactor 200 may include, for example, the catalyst layer 210 and a heat storage body 220.

For example, a perfluorinated compound-containing gas may sequentially pass through the heat storage body 220 and the catalyst layer 210, and in this process, the perfluorinated compounds may be removed. For example, the heat storage body 220 may heat the perfluorinated compound-containing gas to promote a reaction of the perfluorinated compounds with the catalyst layer 210.

Hereinafter, specific experimental examples are proposed to facilitate understanding of the present invention. However, the following examples are only given for illustrating the present invention and those skilled in the art will obviously understand that various alterations and modifications are possible within the scope and spirit of the present invention. Such alterations and modifications are duly included in the appended claims.

### Evaluation Example 1

### (1) Examples 1 to 4, and Comparative Examples 1 and 2

Alumina (Al₂O₃) was used as the first catalyst, and zirconia (ZrO₂) was used as the second catalyst.

77 g of alumina was prepared.

A solution was prepared by dissolving zirconia in an amount so that a ratio of the weight of zirconia to the weight of alumina was the values listed in Table 1 below in distilled water.

77 g of alumina was input and mixed into the prepared solution to be supported. The mixture was first dried at 40° C. and then secondarily dried at 110° C. for 8 hours. The secondarily dried mixture was heated to 750° C. at a rate of 2° C./min and calcined for 6 hours to prepare a catalyst for perfluorinated compound decomposition.

### (2) Evaluation of Initial Activity—CF₄ Removal Efficiency (1 Hour)

7.6 g of each of the catalysts for perfluorinated compound decomposition prepared according to Examples 1 to 4 and Comparative Examples 1 and 2 was separated and filled into a ¾ inch Inconel reaction tube. The reaction temperature was adjusted to 700° C. using an external heater, and a gas containing 3,000 ppm of tetrafluoromethane (CF₄) was passed through the reaction tube for 1 hour.

Detailed reaction conditions are as follows.
i) Air flow rate: 370 cc/min
ii) Distilled water flow rate: 0.04 mL/min
iii) Space velocity: 2,000/hr

CF₄ removal efficiency was calculated using Equation 3 below, and the reactants were analyzed using Fourier transform infrared spectroscopy (FT-IR).

$${CF}_{4} removal efficiency ( \% ) = \{ 1 - ( {C}_{E} / {C}_{I} ) \} * 100 \qquad [ Equation 3 ]$$

In Equation 3, CE is a CF₄ concentration at an outlet of the reaction tube, and C_{I} is a CF₄ concentration at an inlet of the reaction tube.

Evaluation results are shown in Table 1 below.

TABLE 1

| | | CF₄ removal |
|---|---|---|
| | Ratio of weight of zirconia | efficiency (%) |
| Item | to weight of alumina | (1 hour) |
| Example 1 | 0.02 | 93 |
| Example 2 | 0.1 | 96 |
| Example 3 | 0.2 | 95 |
| Example 4 | 0.3 | 92 |
| Comparative example 1 | 0.01 | 88 |
| Comparative example 2 | 0.35 | 89 |

Referring to Table 1, in Examples 1 to 4 where the ratio of the weight of the second catalyst to the weight of the first catalyst was 0.02 to 0.3, the initial efficiency was improved compared to Comparative Examples 1 and 2.

In Comparative Example 1 where the ratio of the weight of the second catalyst to the weight of the first catalyst was less than 0.02, the zirconia content was insufficient, thereby resulting in a decrease in the initial activity compared to the examples.

In Comparative Example 2 where the ratio of the weight of the second catalyst to the weight of the first catalyst exceeded 0.3, the alumina content was reduced, thereby resulting in a decrease in the initial activity compared to the examples.

### Evaluation Example 2

### (1) Examples 5 to 12

Alumina (Al₂O₃), zirconia (ZrO₂) and phosphoric acid (HPO₄) were used as the first, second and third catalysts, respectively.

77 g of alumina was prepared.

A solution was prepared by dissolving zirconia in an amount so that a ratio of the weight of zirconia to the weight of alumina was 0.1, and phosphoric acid in an amount so that a ratio of the weight of phosphoric acid to the weight of alumina was the values listed in Table 2 below in distilled water.

77 g of alumina was input and mixed into the prepared solution to be supported. The mixture was first dried at 40° C. and then secondarily dried at 110° C. for 8 hours. The secondarily dried mixture was heated to 750° C. at a rate of 2° C./min and then calcined for 6 hours to prepare a catalyst for perfluorinated compound decomposition.

### (2) Evaluation of Initial Activity—CF₄ Removal Efficiency (1 Hour)

The initial activity was evaluated in the same manner as (2) of Evaluation Example 1 for the catalysts for perfluorinated compound decomposition prepared according to Examples 5 to 12.

### (3) Evaluation of Lifespan Characteristic—CF₄ Removal Efficiency (300 Hours)

7.6 g of each of the catalysts for perfluorinated compound decomposition prepared according to Examples 5 to 12 was separated and filled into a ¾ inch Inconel reaction tube. The reaction temperature was adjusted to 700° C. using an external heater, and a gas containing 3,000 ppm of CF₄ was passed through the reaction tube for 300 hours.

Detailed reaction conditions were as follows.
i) Air flow rate: 370 cc/min
ii) Distilled water flow rate: 0.04 mL/min
iii) Space velocity: 2,000/hr

CF₄ removal efficiency was calculated using Equation 3 above, and the reactants were analyzed using FT-IR.

### (4) Evaluation of Alumina and Zirconia Crystal Structures

After performing the evaluation of (3) of Evaluation Example 2, the perfluorinated compound catalyst was recovered and XRD analysis was performed on alumina and zirconia.

### 1) Evaluation of Alumina Crystal Structure

XRD peaks corresponding to gamma alumina (γ-alumina), alpha alumina (α-alumina) and aluminum phosphate (AlPO₄) were observed, and peaks appearing in the XRD analysis results were recorded.

### 2) Evaluation of Zirconia Crystal Structure

Evaluation of zirconia crystal structures was performed on the catalysts for perfluorinated compound decomposition prepared according to Examples 5 to 12 through XRD analysis.

Specifically, an area of XRD peaks (2θ 28° and 32°) corresponding to the monoclinic crystal structure (A=a sum of the areas of 2θ 28° peak+32° peak) and an area of XRD peak (2θ 30° peak) corresponding to the hexagonal crystal structure (B=the area of 2θ 30° peak) were measured, and then the measured A and B values were substituted into Equation 1 above to acquire a ratio of the crystal structure of the second catalyst.

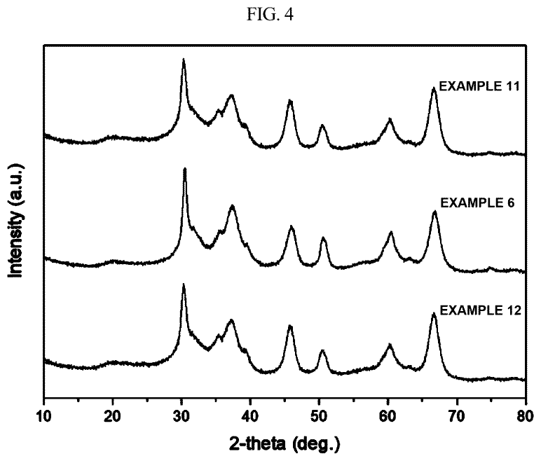

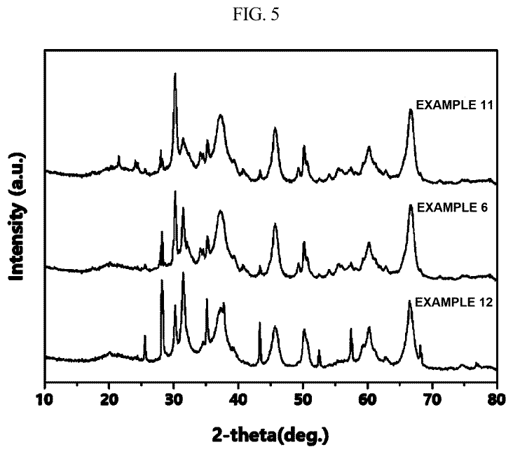

FIGS. 4 and 5 are graphs illustrating XRD analysis results of Examples 6, 11 and 12. Specifically, FIG. 4 is a graph illustrating the XRD analysis results of Examples 6, 11 and 12 measured before injection of CF₄ gas, and FIG. 5 is a graph illustrating the XRD analysis results of Examples 6, 11 and 12 measured after passing CF₄ gas for 300 hours.

Evaluation results are shown in Table 2 below.

TABLE 2

| | Ratio of | | CF₄ | | |
|---|---|---|---|---|---|
| | weight of | CF₄ | removal | | Ratio of |
| | phosphoric | removal | efficiency | Evaluation | zirconia |
| | acid to | efficiency | (%) | of alumina | crystal |
| | weight of | (%) | (300 | crystal | struc- |
| Item | alumina | (1 hour) | hours) | structure | ture |
| Example 5 | 0.01 | 96 | 88 | γ-alumina, | 0.9 |
| | | | | α-alumina | |
| Example 6 | 0.02 | 96 | 94 | γ-alumina, | 0.7 |
| Example 7 | 0.03 | 95 | 94 | γ-alumina | 0.5 |
| Example 8 | 0.05 | 93 | 91 | γ-alumina | 0.3 |
| Example 9 | 0.10 | 90 | 88 | γ-alumina, | 0.2 |
| | | | | AlPO₄ | |
| Example 10 | 0.11 | 88 | 85 | γ-alumina, | 0.2 |
| | | | | AlPO₄ | |
| Example 11 | 0.12 | 85 | 81 | γ-alumina, | 0.15 |
| | | | | AlPO₄ | |
| Example 12 | 0.005 | 96 | 80 | γ-alumina, | 0.92 |
| | | | | α-alumina | |

Referring to Table 2, in Examples 5 to 9 where the ratio of the weight of the third catalyst to the weight of the first catalyst was 0.01 to 0.1, the initial efficiency and lifespan characteristics were improved compared to Examples 10 to 12 which are out of the above range.

In Examples 10 and 11 where the ratio of the weight of the third catalyst to the weight of the first catalyst exceeded 0.1, alumina was transformed into AlPO₄ and the crystal structure of zirconia was relatively significantly transformed into a hexagonal structure. Accordingly, the initial activity and lifespan characteristics of the catalyst for perfluorinated compound decomposition were relatively decreased.

In Example 12 where the ratio of the weight of the third catalyst to the weight of the first catalyst was less than 0.01, the phosphorus-containing compound was insufficient, such that the alumina crystal structure was relatively significantly transformed into alpha alumina. Accordingly, the lifespan characteristics of the catalyst for perfluorinated compound decomposition were relatively decreased.

### Evaluation Example 3

### (1) Examples 13 to 19

Alumina (Al₂O₃), zirconia (ZrO₂), phosphoric acid (HPO₄) and zinc (Zn) were used as the first, second, third and fourth catalysts, respectively.

77 g of alumina was prepared.

A solution was prepared by dissolving zirconia in an amount so that a ratio of the weight of zirconia to the weight of alumina was 0.1, phosphoric acid in an amount so that the ratio of the weight of phosphoric acid to the weight of alumina was 0.01, and zinc in an amount so that the ratio of the weight of zinc to the weight of alumina was the values listed in Table 3 below in distilled water.

77 g of alumina was input and mixed into the prepared solution to be supported. The mixture was first dried at 40° C. and second dried at 110° C. for 8 hours. The secondary dried mixture was heated to 750° C. at a rate of 2° C./min and calcined for 6 hours to prepare a catalyst for perfluorinated compound decomposition.

### (2) Evaluation of Initial Activity—CF₄ Removal Efficiency (1 Hour)

The initial activity was evaluated in the same manner as (2) of Evaluation Example 1 for the catalysts for perfluorinated compound decomposition prepared according to Examples 13 to 19.

### (3) Evaluation of Lifespan Characteristic—CF₄ Removal Efficiency (300 Hours)

The lifespan characteristic evaluation was performed on the catalysts for perfluorinated compound decomposition prepared according to Examples 13 to 19 in the same manner as (3) of Evaluation Example 2, except that the reaction temperature was adjusted to 650° C.

### (4) Evaluation of Alumina Crystal Structure

XRD peaks corresponding to gamma alumina (γ-alumina) and zinc aluminate (ZnAl₂O₄) were observed, and peaks appearing in the XRD analysis results were recorded.

Evaluation results are shown in Table 3 below.

TABLE 3

| | Ratio of | CF₄ | CF₄ | |
|---|---|---|---|---|
| | weight of | removal | removal | Evaluation |
| | zinc to | efficiency | efficiency | of alumina |
| | weight of | (%) | (%) | crystal |
| Item | alumina | (1 hour) | (300 hours) | structure |
| Example 6 | 0 | 96 | 88 | γ-alumina |
| Example 13 | 0.01 | 97 | 90 | γ-alumina |
| Example 14 | 0.04 | 99 | 92 | γ-alumina |
| Example 15 | 0.07 | 100 | 95 | γ-alumina |
| Example 16 | 0.09 | 100 | 93 | γ-alumina |
| Example 17 | 0.12 | 100 | 93 | γ-alumina |
| Example 18 | 0.20 | 96 | 91 | γ-alumina |
| Example 19 | 0.30 | 92 | 85 | γ-alumina, |
| | | | | ZnAl₂O₄ |

Referring to Table 3, in Examples 13 to 18 where the ratio of the weight of the fourth catalyst to the weight of the first catalyst was 0.01 to 0.2, the lifespan characteristics were relatively improved compared to Examples 6 and 19 which are out of the above range.

In Example 6 where the fourth catalyst was not included, the lifespan characteristics when the reaction temperature was less than 700° C. (650° C.) were decreased.

In Example 19 where the fourth catalyst was included in excess, the alumina crystal structure was transformed into ZnAl₂O₄, and accordingly, the lifespan characteristics of the catalyst for perfluorinated compound decomposition were decreased.

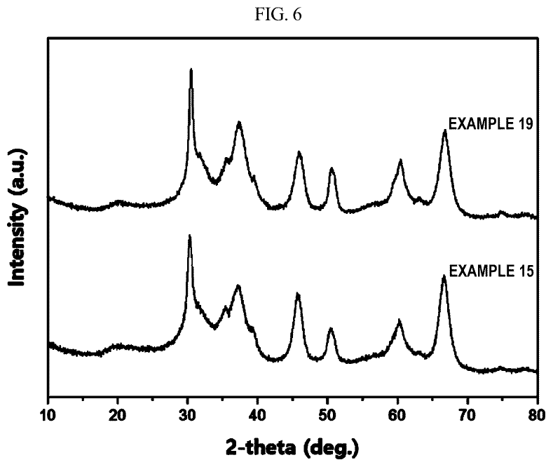

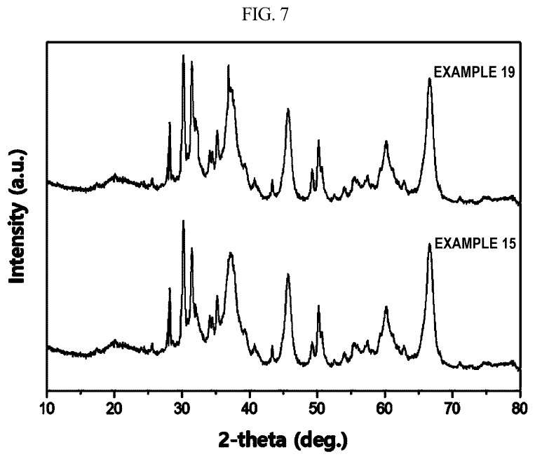

FIGS. 6 and 7 are graphs illustrating XRD analysis results of Examples 15 and 19. Specifically, FIG. 6 is a graph illustrating the XRD analysis results of Examples 15 and 19 measured before injection of CF₄ gas, and FIG. 7 is a graph illustrating the XRD analysis results of Examples 15 and 19 measured after CF₄ gas was passed through them for 300 hours.

Referring to FIGS. 6 and 7, in Example 19 where the ratio of the weight of zinc to the weight of alumina exceeded 0.2, the peak corresponding to the zinc compound (2θ about 32°) was significantly increased. Accordingly, the CF₄ removal efficiency was relatively decreased compared to other examples.

### Evaluation Example 4

### (1) Examples 20 to 24

A mixture of alumina was prepared by mixing 2,700 g of gamma alumina and 300 g of a molding aid (glycol additive, ether additive).

A solution was prepared by dissolving 87 g of zinc nitrate, 54 g of phosphoric acid (HPO₄), and 195 g of zirconia in distilled water.

A mixture was prepared by adding and mixing the prepared alumina mixture to the prepared solution. The prepared mixture was put into an extrusion molding machine to prepare a molded body having a honeycomb structure shape.

At this time, the extrusion molding machine was set so that a ratio (i.e., the channel length ratio of Equation 2 above) of the length L of one through channel in the planar direction to the shortest distance T between the adjacent through channel adjacent to one side of the catalyst for perfluorinated compound decomposition and the one side was 4.

After rapidly drying the prepared molded body, the catalyst for perfluorinated compound decomposition was prepared by calcining at 110° C. for 4 hours, 550° C. for 2 hours, and 750° C. for 4 hours at a heating rate of 5° C./min.

### (2) Evaluation of Lifespan Characteristic—CF₄ Removal Efficiency (300 Hours)

Evaluation of lifespan characteristics was performed on the catalysts for perfluorinated compound decomposition prepared according to Examples 20 to 24 in the same manner as (3) of Evaluation Example 2.

Evaluation results are shown in Table 4 below.

TABLE 4

| | | CF₄ removal efficiency (%) |
|---|---|---|
| Item | L/T | (300 hours) |
| Example 20 | 0.8 | — |
| Example 21 | 1 | 92 |
| Example 22 | 2.5 | 90 |
| Example 23 | 5 | 85 |
| Example 24 | 6 | 60 |

Referring to Table 4, in Examples 21 to 23 where the channel length ratio (L/T) was 1 to 5, CF₄ removal efficiency after long-term operation was improved compared to Examples 20 and 24 which are out of the above range.

In Example 20 where the channel length ratio is less than 1, the pressure loss of the gas to be treated passing through the through channels was relatively increased. Accordingly, the lifespan characteristics were relatively decreased.

In Example 24 where the channel length ratio exceeds 5, the specific surface area of the catalyst for perfluorinated compound decomposition was relatively decreased. Accordingly, the decomposition efficiency of perfluorinated compounds per weight of the catalyst for perfluorinated compound decomposition was relatively decreased.

1: A catalyst comprising:
a first catalyst comprising an aluminum oxide; and
a second catalyst comprising at least one oxide selected from the group consisting of Zr, Ce and Ga,
wherein a ratio of a weight of the second catalyst to a total weight of the first catalyst is 0.02 to 0.3.

2: The catalyst according to claim 1, wherein the aluminum oxide comprises at least one form selected from the group consisting of boehmite (hydrated alumina), alpha alumina (α-alumina), gamma alumina (γ-alumina), delta alumina (δ-alumina) and theta alumina (θ-alumina).

3: The catalyst according to claim 1, wherein the second catalyst comprises at least one selected from the group consisting of zirconium oxide (ZrO₂), cerium oxide (CeO₂) and gallium oxide (Ga₂O₃).

4: The catalyst according to claim 1, wherein the second catalyst comprises at least one selected from the group consisting of zirconium oxide, cerium oxide and gallium oxide, and a mixed phase of alumina and phosphorus.

5: The catalyst according to claim 1, further comprising a third catalyst comprising a phosphorus-containing compound.

6: The catalyst according to claim 5, wherein a ratio of a converted weight of phosphorus included in the third catalyst to a total weight of the first catalyst is 0.01 to 0.1, and
the converted weight of phosphorus is a weight obtained by converting the content of phosphorus included in the third catalyst to a content of P₂O₅.

7: The catalyst according to claim 5, wherein the third catalyst further comprises a compound containing at least one selected from the group consisting of B, S, P, Cs, Ca and K.

8: The catalyst according to claim 5, further comprising a fourth catalyst comprising at least one oxide selected from the group consisting of Zn, Ni, W, Co, Ni, Cr and Mo.

9: The catalyst according to claim 1, wherein a ratio of a crystal structure of the second catalyst, which is measured through X-ray diffraction (XRD) analysis and defined by Equation 1 below, is 0.2 to 0.9:
$$Ratio of crystal structures = A / B \qquad [ Equation 1 ]$$
wherein Equation 1, A is an XRD peak area corresponding to a monoclinic crystal structure of the second catalyst, and B is an XRD peak area corresponding to a tetragonal crystal structure of the second catalyst.

10: The catalyst according to claim 9, wherein a ratio of the weight of the fourth catalyst to the total weight of the first catalyst is 0.01 to 0.2.

11: The catalyst according to claim 1, wherein a ratio of the weight of the first catalyst to a total weight of the catalyst is 0.67 to 0.96.

12: The catalyst according to claim 1, wherein the catalyst has a honeycomb structure shape comprising a plurality of through channels formed therein.

13: The catalyst according to claim 12, wherein the number of through channels per square inch (CPSI) in a planar direction perpendicular to an extension direction of the plurality of through channels is 50 to 150.

14: The catalyst according to claim 12, wherein a channel length ratio defined by Equation 2 below is 1 to 5:
$$Channel length ratio = L / T \qquad [ Equation 2 ]$$
wherein Equation 2, L is a length of a major axis of each of the plurality of through channels in the planar direction, and T is the shortest distance between a through channel adjacent to one side of the catalyst and the one side.

15: An apparatus for perfluorinated compound decomposition, the apparatus comprising:
a catalyst layer comprising the catalyst for perfluorinated compound decomposition of claim 12; and
a heat storage body disposed on a lower portion of the catalyst layer.
